(19) United States
(12) Patent Application Publication
(10) Pub. No.: US 2024/0382361 A1
(43) Pub. Date: Nov. 21, 2024

(54) COMPACT MECHANISM FOR SURGICAL TABLE MOTION

(71) Applicant: Intuitive Surgical Operations, Inc., Sunnyvale, CA (US)

(72) Inventor: Bram Gilbert Antoon Lambrecht, Sunnyvale, CA (US)

(73) Assignee: Intuitive Surgical Operations, Inc., Sunnyvale, CA (US)

(21) Appl. No.: 18/664,888

(22) Filed: May 15, 2024

Related U.S. Application Data
(60) Provisional application No. 63/466,506, filed on May 15, 2023.

(51) Int. Cl. A61G 13/04; A61G 13/06; A61G 13/08

(52) U.S. Cl. CPC A61G 13/04; A61G 13/06; A61G 13/08; A61G 2203/10

(57) ABSTRACT

A surgical table includes a tabletop with a top surface and an underside. The surgical table further includes a support column that elevates the tabletop relative to a floor along a column axis. In addition, the surgical table includes a compact tilt mechanism connecting the support column and the tabletop. The surgical table also includes at least one mechanical interface for attaching a device to the tabletop.

### CROSS-REFERENCE TO RELATED APPLICATIONS

This patent application claims the benefit of priority under 35 U S.C. § 119 (e) to U.S. Provisional Patent Application Ser. No. 63/466,506, filed on May 15, 2023, which is hereby incorporated by reference herein in its entirety.

### FIELD

The present disclosure is directed to systems and methods for orienting a tabletop of surgical tables.

### BACKGROUND

A surgical table can be used during a surgical operation to support and position a patient. During the surgical procedure, a surgeon may wish to position the patient in a way that allows gravity to adjust the organs in the surgical field, and/or to improve access to the anatomy by the surgeon or staff, an instrument, a robot, or any other equipment. That is, the surgeon may desire to tilt the patient about one or more degrees of freedom relative to the gravitational field (i.e., relative to the ground). To enable the positioning of the patient, surgical tables or beds can include one or more devices to adjust the angle of the patient relative to the ground.

### SUMMARY

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

In general, in one aspect, embodiments relate to a surgical table comprising: a tabletop comprising: a top surface, and an underside; a support column that elevates the tabletop relative to a floor along a column axis; at least one mechanical interface for attaching a device to the tabletop; and a tilt mechanism connecting the support column and the tabletop, comprising: a center pivot that defines a principal axis and couples the underside of the tabletop to the support column; and a tilt drive mechanism to rotate the tabletop about the principal axis, comprising: a first link having a first end and a second end; and a first joint rotatably coupled to the underside of the tabletop; wherein the first end of the first link is connected to the support column and the second end is connected to the first joint, wherein the first link is extendable and retractable along a first link axis between the support column and the underside of the tabletop to cause the tabletop to tilt about the principal axis, the first link axis being non-parallel to the column axis.

In general, in one aspect, embodiments relate to A surgical table comprising: a tabletop comprising: a top surface, and an underside; a support column that elevates the tabletop relative to a floor; at least one mechanical interface for attaching a device to the tabletop; and a tilt mechanism connecting the support column and the tabletop, comprising: a center pivot that defines a principal axis and couples the underside of the tabletop to the support column; and a tilt drive mechanism to rotate the tabletop relative to the support column about the principal axis, comprising: a motor; a first gear fixedly attached to the center pivot; and a second gear driven by the motor and positioned to mesh with the first gear; wherein the second gear transmits torque to the first gear to adjust an angular position of the tabletop in response to being driven by the motor.

In general, in one aspect, embodiments relate to a surgical table comprising: a tabletop comprising: a top surface, and an underside; a support column that elevates the tabletop relative to a floor; at least one mechanical interface for attaching a device to the tabletop; and a tilt mechanism connecting the support column and the tabletop, comprising: a center pivot that defines a principal axis and couples the underside of the tabletop to the support column; and a tilt drive mechanism to rotate the tabletop relative to the support column about the principal axis, comprising: a linear actuator with a first end rotatably connected to the support column and a second end, wherein the linear actuator is configured with an adjustable length; and a bellcrank comprising: a fixed pivot rotatably connected to the support column; a first moving pivot coupled to an underside of the tabletop; and a second moving pivot coupled to the second end of the linear actuator; wherein an angular position of the tabletop is adjusted in response to changes of the adjustable length of the linear actuator.

In cases where the present specification and a document incorporated by reference include conflicting and/or inconsistent disclosure, the present specification shall control. If two or more documents incorporated by reference include conflicting and/or inconsistent disclosure with respect to each other, then the document having the later effective date shall control.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 depicts a teleoperated surgical system in accordance with one or more embodiments.

FIG. 2 depicts a simplified diagram of a surgical table in accordance with one or more embodiments.

FIG. 3A depicts the rotation of a plane parallel to a top surface of a tabletop relative to a longitudinal axis in accordance with one or more embodiments.

FIG. 3B depicts the rotation of a plane parallel to a top surface of a tabletop relative to a transverse axis in accordance with one or more embodiments.

FIG. 4 depicts a compact tilt mechanism in accordance with one or more embodiments.

FIG. 5 depicts a non-compact tilt mechanism.

FIG. 6 depicts generalized aspects of a surgical table with a compact tilt mechanism in accordance with one or more embodiments.

FIG. 7 depicts an example compact tilt mechanism in accordance with one or more embodiments.

FIG. 8 depicts an example compact tilt mechanism in accordance with one or more embodiments.

FIG. 9 depicts an example compact tilt mechanism in accordance with one or more embodiments.

FIG. 10 depicts an example compact tilt mechanism in accordance with one or more embodiments.

FIG. 11 depicts an example compact tilt mechanism in accordance with one or more embodiments.

### DETAILED DESCRIPTION

During surgical procedures, a surgical table can be supplied to support and position a patient. Dependent on the operation and/or preferences of the attending surgeon, it is often desirable to adjust the position of the patient. For example, by tilting the patient, positions of the patient's organs can be naturally adjusted and maintained by gravity in such a way to aid in the surgical procedure. Thus, to position the patient, surgical tables are often equipped with one or more tilt mechanisms.

The range of motion of a surgical table about an axis of rotation can be specified by a standard range of tilt angles, [θₘᵢₙ, θₘₐₓ], where θₘᵢₙ is a minimum tilt angle and θₘₐₓ is a maximum tilt angle. Herein, square brackets [⋅] indicate inclusion of the endpoints in the given range and parenthetical brackets (⋅) indicate that associated endpoints are not included in the given range. That is, given a tilt angle θ, [θₘᵢₙ, θₘₐₓ] is equivalent to θₘᵢₙ≤θ≤θₘₐₓ≥(θₘᵢₙ, θₘₐₓ) is equivalent to θₘᵢₙ<θ<θₘₐₓ, (θₘᵢₙ, θₘₐₓ] is equivalent to θₘᵢₙ<0≤θₘₐₓ, and [θₘᵢₙ, θₘₐₓ) is equivalent to θₘᵢₙ≤0<θₘₐₓ. It may be said that the standard range of tilt angles defines an originally-specified range of motion for the surgical table. In instances where a surgical table can be tilted, or rotated, about more than one axis of rotation by one or more tilt mechanisms, a standard range of tilt angles, and thus an originally-specified range of motion, can be independently supplied for each axis of rotation.

Increasingly, devices and tools are being attached to, or integrated with, surgical tables. In some instances, devices and tools are stored beneath the surgical table. These devices and tools, whether in use or in storage, can contact and conflict with the tilt mechanism(s) of the surgical table; especially when the surgical table is rotated about one or more axes of rotation by the tilt mechanism(s). Due to collisions between the tilt mechanism(s) and the attached, or integrated, tools and devices, the range of motion of the surgical table about an axis of rotation can be limited to a range of tilt angles less than, or bounded by, the standard range of tilt angles for said axis of rotation. That is, collisions between the tilt mechanism(s) and the attached tools and devices can limit a tilt angle θ about a given axis of rotation of the surgical table to one of the following ranges: (θₘᵢₙ, θₘₐₓ], [θₘᵢₙ, θₘₐₓ), and (θₘᵢₙ, θₘₐₓ), where θₘᵢₙ and θₘₐₓ represent the inclusive bounds of the standard range of tilt angles for the given axis of rotation of the surgical table before attachment of additional tools and devices to the surgical table. Limited or reduced surgical table range of motion can prohibit the optimal positioning of a patient during a procedure, such as a surgical procedure. Accordingly, there exists a need for a compact tilt mechanism for surgical tables capable of retaining the originally-specified range of motion or at least a meaningful range of motion for the surgical table without colliding with tools or devices that can be attached or otherwise integrated with the surgical table.

Embodiments disclosed herein relate to a compact tilt mechanism for adjusting the angle of a table about an axis of rotation without reducing or limiting an originally-specified range of motion for the table even in the presence of devices and/or tools attached to, integrated with, and/or stowed underneath the table. One with ordinary skill in the art will recognize that tools and/or devices attached to a table can be attached and positioned at the discretion of a user. As such, it is possible for a user to attach and position a tool or device in bad faith such that it collides with any proposed embodiment of a compact tilt mechanism and prohibits the range of motion from achieving the originally-specified range of motion. As such, one with ordinary skill in the art will readily appreciate that embodiments disclosed herein are described under the reasonable assumption that any tools and devices attached to and positioned with respect to a table by a user are attached and positioned as would be practical given the context of a real-world scenario and with common sense.

While embodiments of the compact tilt mechanism disclosed herein will generally describe an angular adjustment of the table about a single axis, multiple compact tilt mechanisms can be used in combination to support adjustment over additional degrees of freedom without limitation. Further, while embodiments described herein may discuss the compact tilt mechanism in the context of, or use with, surgical tables, this does not impose a limitation on the instant disclosure. In general, the compact tilt mechanism can be used with any type of table. That is, embodiments of the compact tilt mechanism disclosed herein are not limited for use with surgical tables or surgical environments. Further, although some of the examples described herein refer to surgical procedures or tools (e.g., a surgical table), or medical procedures and medical tools, the techniques disclosed apply to medical and non-medical procedures, and to medical and non-medical tools. For example, the tools, systems, and surgical table described herein can be used for non-medical purposes including industrial uses, general robotic uses, and sensing or manipulating non-tissue work pieces. Other example applications involving one or more embodiments disclosed herein may include cosmetic improvements, imaging of human or animal anatomy, gathering data from human or animal anatomy, setting up or taking down the system, and training medical or non-medical personnel. Additional example applications include use for procedures on tissue removed from human or animal anatomies (without return to a human or animal anatomy) and performing procedures on human or animal cadavers. Further, procedures and tools described herein can also be used for medical treatment or diagnosis procedures that do, or do not, include surgical aspects. Specific embodiments of such a compact tilt mechanism are detailed further below.

In the following description, specific details are set forth describing some embodiments consistent with the present disclosure. Numerous specific details are set forth in order to provide a thorough understanding of the embodiments. It will be apparent, however, to one skilled in the art that some embodiments can be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

In some instances, well known methods, procedures, components, and circuits have not been described in detail so as not to unnecessarily obscure aspects of the embodiments. For example, devices and substitutes that provide or enable linear actuation, such as pneumatic cylinders and lead screws are well understood without detailed descriptions of aspects of such devices like gaskets, thread pitch, etc. Thus, specific descriptions regarding such devices, procedures, components, and how circuits can be integrated with, or used within, embodiments of the instant disclosure are omitted herein for concision where applicable without causing undue ambiguity or uncertainty.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element can encompass more than one element and succeed (or precede) the second element in an ordering of elements.

It is to be understood that the singular forms “a,” “an,” and “the” include plural referents unless the context clearly dictates otherwise. Thus, for example, reference to “an axis” includes reference to one or more of such axes.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

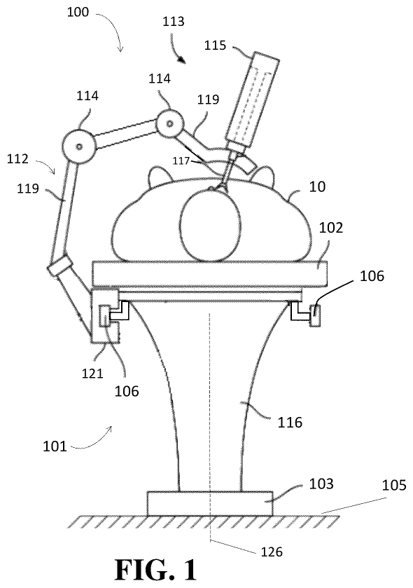

In the following description of FIGS. 1-11, any component described with regard to a figure, in various embodiments disclosed herein, may be equivalent to one or more like-named components described with regard to any other figure. For brevity, descriptions of these components are not necessarily repeated with regard to each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described with regard to a corresponding like-named component in any other figure.

This disclosure describes various instruments and portions of instruments in terms of their state in three-dimensional space. In particular, embodiments disclosed herein relate to the angular rotation of a table (or more specifically, a tabletop) about one or more axes of rotation. As used herein, the term “position” generally refers to the angular position of a tabletop relative to one or more axes in a three-dimensional space (e.g., three degrees of rotational freedom along a set of orthogonal axes such as the x-, y-, and z-axes of a Cartesian coordinate system). In some instances, the term “orientation” may also refer to the angular position or rotational placement of a tabletop. For example, the orientation of a patient upon a surgical table may be adjusted and/or maintained with the compact tilt mechanism in accordance with one or more embodiments.

Turning to the figures, specific non-limiting embodiments are described in further detail. It should be understood that the various systems, components, features, and methods described relative to these embodiments can be used either individually and/or in any desired combination as the disclosure is not limited to only the specific embodiments described herein.

FIG. 1 depicts a teleoperated surgical system with a teleoperated surgical manipulator system 100 in accordance with one or more embodiments. Manipulator system 100 is a teleoperated system for performing minimally invasive surgery on a patient's body 10 positioned on a surgical table 101.

The surgical table 101 includes a tabletop 102 on which the patient's body 10 is placed and a support column 116 vertically extending along a column axis 126 that supports and elevates the tabletop 102 above a floor surface 105. The surgical table can further include a base 103 supporting and connecting the support column 116 to the floor surface 105, and at least one mechanical interface for attaching a device to the surgical table 101. The in the example of FIG. 1, the at least one mechanical interface is a rail system 106. Although FIG. 1 depicts the at least one mechanical interface as a rail system 106, other configurations and arrangements are considered, such as clevis fastener, interference fit, etc. Further, although FIG. 1 illustrates the base 103 as statically grounded to the floor surface 105 by a single, centrally located support column 116, other suitable surgical tables 101 can have a horizontally extending pillar, a wheeled base, a base designed to slide along a track or rail, and/or a multi-legged support system. The surgical table 101 can be provided in the form of any structure suitable for supporting a patient during a medical procedure.

Generally, a rail system 106 consists of elongated structures, or rails that extend lengthwise along surgical table 101. In the example of FIG. 1, the rails of the rail system 106 have a rectangular cross section and are located below the tabletop 102. Other suitable rail configurations and arrangements are also contemplated. For example, rails suitable for use with techniques of the instant disclosure can be continuous along a given dimension of the surgical table 101, intermittent, be disposed laterally with respect to the tabletop 102, and/or can have a “C”-shaped cross section, or any other shape that enables a removable or non-removable securing of any type of equipment to the rail system. For example, a clamp can be used to secure equipment to the rail system 106. Further, the rail system 106 need not be located below the tabletop 102. In one or more embodiments, the rail system 106 is disposed on the side(s) of the tabletop 102.

The manipulator system 100 depicted in FIG. 1 further includes a manipulator arm 112, as an example device, fixedly attached to the surgical table 101 by the rail system 106. The manipulator arm 112 includes an instrument manipulator 113 with an instrument carriage 115 at a distal end of instrument manipulator 113. The instrument carriage 115 supports a detachable surgical instrument 117. The instrument manipulator 113 controls positioning of surgical instrument 117 relative to the patient's body 10. One or more optional proximal links 119 can function as a setup arm portion of the manipulator arm 112. As seen, the manipulator arm 112 can have a plurality of joints 114 to provide articulation and movement of the manipulator arm 112. Setup arm portions (e.g., proximal links 119) can be manually moved or teleoperated, powered or unpowered.

In the example of FIG. 1, the manipulator arm 112 attaches to rail system 106 via a coupler 121. The coupler 121 can be configured (i.e., functionally designed and sized) to releasably secure the manipulator arm 112 to the rail system 106 in a fixed position. In one or more embodiments, the coupler 121 includes a clamp for this purpose. The clamp can be operated in a manner that transitions the coupler 121 between a locked state and an unlocked state, which enables selective movement of the manipulator arm 112 along the rail system 106 for adjustment of the location of the manipulator arm 112 relative to the patient's body 10. In one or more embodiments, the coupler 121 is a linear bearing that directly engages with the rail system 106. The linear bearing enables a translation along the rail system 106 and may be equipped with a motor and/or a brake.

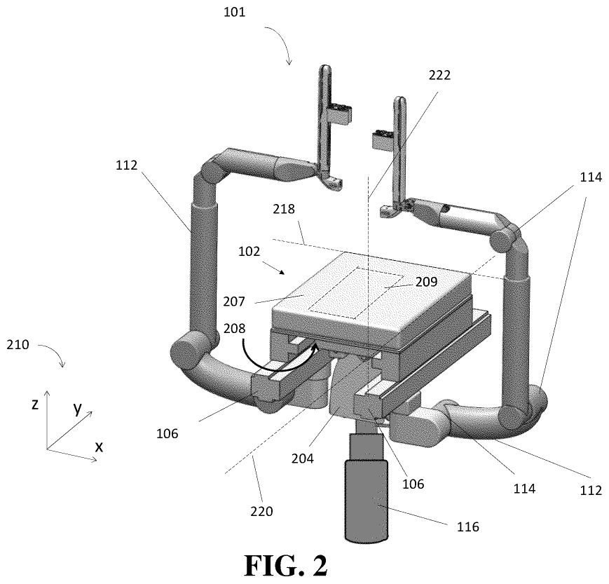

FIG. 2 is a simplified diagram of a surgical table 101 in accordance with one or more embodiments. For clarity, only a portion of the surgical table 101 is depicted in FIG. 2. The surgical table 101 is suitable for use in a surgical operation or procedure. In one or more embodiments, the surgical table includes a tabletop 102, a compact tilt mechanism 204, and at least one mechanical interface for attaching a device to the surgical table 101. In the example of FIG. 2, and in subsequent examples, the at least one mechanical interface is depicted as a rail system 106. Herein, for simplicity and concision, embodiments are depicted using rail system 106 as an example for the at least one mechanical interface. However, embodiments are not limited to surgical tables 101 employing a rail system 106 as a mechanical interface for attaching a device to the surgical table 101.

The tabletop 102 can be said to further include a top surface 207 and an underside 208. For illustrative purposes, FIG. 2 also depicts a right-handed reference coordinate system 210 with three orthogonal axes labeled as the x-axis, y-axis, and z-axis. The reference coordinate system 210 defines a fixed frame but is otherwise arbitrary. As will be shown, the depicted orientation of the reference coordinate system 210 is conveniently chosen but does not impose a limitation on the surgical table 101. A patient can be placed on the top surface 207 of the tabletop 102. In one or more embodiments, the underside 208 of the tabletop 102 forms a connection, or otherwise includes, the rail system 106 of the surgical table 101. The rail system 106 allows for tools or devices to be attached to, or integrated with, the surgical table 101. In particular, tools or devices attached to, or integrated with, the surgical table 101 move/rotate with the surgical table 101 as the surgical table 101 is raised/lowered, rotated, and/or tilted as will be explained in greater detail below.

FIG. 2 depicts manipulator arms 112, as an example device, attached to surgical table 101 via the rail system 106. A detailed description of the manipulator arms 112 is beyond the scope of this disclosure. It suffices to say that the manipulator arms 112 can be considered a tool or device to aid in, or perform, a process or procedure such as a surgical procedure. Examples of manipulator arms 112 can include one or more robotic surgical arms configured for control by a surgeon while performing a surgical procedure and programmable robotic arms configured to manipulate an object on, or proximate to, a table (e.g., automated manufacturing, packaging, etc.). As seen, in FIG. 2, the manipulator arms 112 have a plurality of joints 114 to provide articulation and movement of the manipulator arms 112. Note that in FIG. 2, not all joints 114 of the manipulator arms 112 are annotated to avoid cluttering the figure. In some instances, when not in use or while transferring a patient onto and off of the tabletop 102, the manipulator arms 112 can be positioned and stowed underneath the surgical table 101 (i.e., proximate the underside 208). While manipulator arms 112 are provided as an example of a device or tool that can be attached to the surgical table 101, embodiments disclosed herein are not limited to only use cases involving manipulator arms 112. In general, embodiments disclosed herein can be applied to a surgical table 101 with any attached device or tool. Further, attached or integrated devices and tools are not limited to attachment solely through the rail system 106.

FIG. 2 also defines a transverse axis 218, a longitudinal axis 220, and a vertical axis 222. The transverse axis 218, longitudinal axis 220, and vertical axis 222 differ from the reference coordinate system 210 in that the reference coordinate system 210 is considered a fixed coordinate system. As will be seen, the transverse axis 218, longitudinal axis 220, and vertical axis 222 need not remain fixed in space nor remain mutually orthogonal. In the depiction of FIG. 2, the transverse axis 218 is parallel with the x-axis, the longitudinal axis 220 is parallel with the y-axis, and the vertical axis is parallel with the z-axis of the reference coordinate system 210, however, it is emphasized this need not remain the case.

In general, the longitudinal axis 220 extends along the length of the surgical table 101, or from the “head-to-toc” of a patient lying prone or supine on the tabletop 102. The transverse axis 218 extends along the width of the surgical table 101, or from “shoulder-to-shoulder” of a patient lying prone or supine on the tabletop 102.

Herein, the transverse axis 218, longitudinal axis 220, and vertical axis 222 are positioned on the surgical table 101 as to provide a reference for rotational and translational movement of the tabletop 102. For example, as seen in FIG. 2, typically the surgical table 101 is supported by a support column 116. The support column 116 can be a single post, multiple posts, or other body that makes contact with the ground or floor (not shown) and elevates the tabletop 102 above the ground. In the example of FIG. 2, the vertical axis 222 is positioned coaxially with the support column 116. In some embodiments, the support column is designed to be able to raise or lower the tabletop 102 along the vertical axis 222 (e.g., by means of a telescoping post). Further, in some embodiments, the tabletop 102 is rotatable around the vertical axis 222 (i.e., the vertical axis 222 defines an axis of rotation) by means of the support column 116.

As stated, a surgical table 101 can include a compact tilt mechanism 204. In one or more embodiments, the compact tilt mechanism 204 is disposed between the support column 116 and the underside 208 of the tabletop 102. The compact tilt mechanism 204 is configured so that the tabletop 102 of the surgical table 101 can rotate about one or more axes of rotation. In the example of FIG. 2, the transverse axis 218 is positioned to define a transverse axis of rotation, where rotation of the tabletop 102 relative to the transverse axis 218 raises or lowers the head or feet of a patient. That is, rotation of the tabletop 102 relative to the transverse axis 218 can be used to position a patient that is lying prone or supine on the tabletop 102 into the so-called Trendelenburg and reverse Trendelenburg positions. Likewise, the longitudinal axis 220 is positioned so as to define a longitudinal axis of rotation, where rotation of the tabletop 102 relative to the longitudinal axis 220 can tilt the right or left side of a patient lying prone or supine on the tabletop 102 up and down.

A first plane 209 is defined as a plane that is parallel to the top surface 207 of the tabletop 102. In FIG. 2, the first plane 209 is also parallel with a plane formed by the x-axis and y-axis of the reference coordinate system 210, however, in general, due to rotation of the tabletop 102 the first plane 209 is not restricted to be coplanar with the x-axis and y-axis of the reference coordinate system 210.

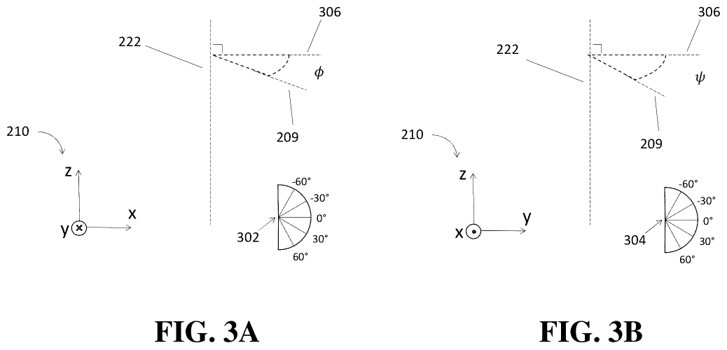

FIGS. 3A and 3B serve to establish a nomenclature used herein to describe the rotation of the tabletop 102 relative to the longitudinal axis 220 and transverse axis 218, respectively. First, in both FIGS. 3A and 3B, a horizontal plane 306 is defined orthogonal to the vertical axis. Further, the reference coordinate system 210 is provided in both FIGS. 3A and 3B to aid in orientation. In particular, FIG. 3A is viewed along the y-axis of the reference coordinate system 210 and FIG. 3B is viewed along the x-axis of the reference coordinate system 210. When the tabletop 102 is rotated about the longitudinal axis 220, the intersection of the x-z plane and the first plane 209 forms a first angle ϕ relative to the intersection of the x-z plane and the horizontal plane 306, as depicted in FIG. 3A. Herein, the value of the first angle ϕ is given according to a first angular datum 302, where the first angular datum 302 is coplanar with the x-z plane. Thus, the first angle ϕ is said to be zero when the intersection of the x-z plane and the first plane 209 is coplanar with the horizontal plane 306. Likewise, when the tabletop 102 is rotated about the transverse axis 218, the intersection of the y-z plane and the first plane 209 forms a second angle ψ relative to the intersection of the y-z plane and the horizontal plane 306, as depicted in FIG. 3B. Herein, the value of the second angle ψ is given according to a second angular datum 304, where the second angular datum 304 is coplanar with the y-z plane. Thus, the second angle ψ is said to be zero when the intersection of the y-z plane and the first plane 209 is coplanar with the horizontal plane 306.

In general, the tabletop 102 of the surgical table 101 can be rotated about the transverse axis 218 and longitudinal axis 220 independently and concurrently. Further, an originally-specified range of motion (i.e., the range of motion of the tabletop 102 about an axis before attachment of tools and/or devices) can be independently specified for rotation about both the transverse axis 218 and the longitudinal axis 220. Without loss of generality, an originally-specified range of motion for rotation about the longitudinal axis 220 is given by a first standard range of tilt angles, [ϕₘᵢₙ, ϕₘₐₓ] and an originally-specified range of motion for rotation about the transverse axis 218 is given by a second standard range of tilt angles, [ψₘᵢₙ, ψₘₐₓ]. In one or more embodiments, ϕₘᵢₙ=−20 degs, ϕₘₐₓ=20 degs, ψₘᵢₙ=−35 degs, and ψₘₐₓ=35 degs.

In one or more embodiments, rotation of the tabletop 102 about both the transverse axis 218 and the longitudinal axis 220 is facilitated by the compact tilt mechanism 204. In other embodiments, two compact tilt mechanisms 204 are paired and configured to operate independently where one compact tilt mechanism facilitates rotation of the tabletop 102 about the transverse axis 218 and the other facilitates rotation of the tabletop 102 about the longitudinal axis 220. Hereafter, all embodiments of the compact tilt mechanism 204 will be described and depicted with the compact tilt mechanism 204 facilitating rotation of the tabletop 102 about the longitudinal axis 220. One with ordinary skill in the art will recognize that this choice of description and depiction is intended to promote clarity and concision and does not impose a limitation on the instant disclosure. All statements regarding the compact tilt mechanism 204 described herein with reference to rotation about the longitudinal axis 220 also apply to rotation about the transverse axis 218. To further emphasize that embodiments the of compact tilt mechanism 204 disclosed herein are agnostic to the axis about which they facilitate rotation, the term principal axis, among other generalizing terms, will be adopted, wherein the principal axis may refer to the transverse axis 218 or the longitudinal axis 220 of a surgical table. The principal axis may or may not be spatially fixed. For example, more complex mechanisms can have a virtual pivot center that translate through the resulting range of motion.

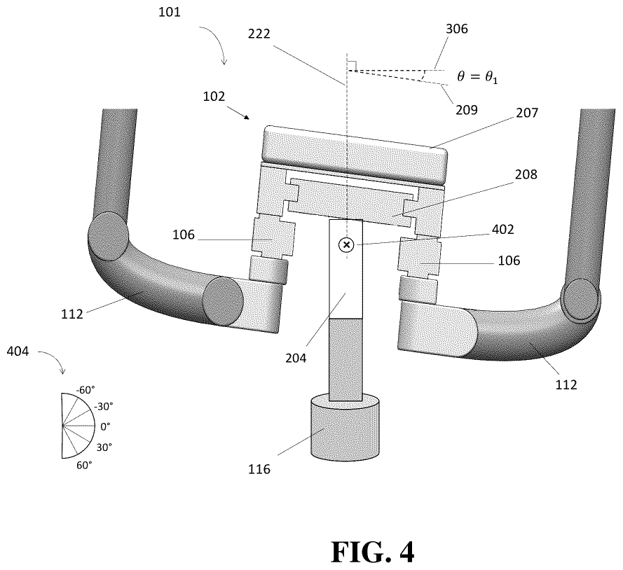

In FIG. 4, the compact tilt mechanism 204 is disposed between, and forms a connection between, the support column 116 and the underside 208 of the tabletop 102. FIG. 4 further depicts a principal axis 402 about which the tabletop 102 can be rotated. As seen in FIG. 4, the tabletop 102 is rotated about the principal axis 402 such that the intersection of the first plane 209 and a plane orthogonal to the principal axis 402 relative to the intersection of the horizontal plane 306 and the plane orthogonal to the principal axis 402 forms a tilt angle θ. Here, the term tilt angle θ is used to promote the concept that the compact tilt mechanism 204 is axis-agnostic. For rotation of the tabletop 102 about the principal axis 402, a standard range of tilt angles, [θₘᵢₙ, θₘₐₓ], is given. Further, the value of the tilt angle θ is defined according to an angular datum 404.

Continuing with FIG. 4, the rail system 106 and attached, or otherwise integrated, tools and devices (i.e., the manipulator arms 112) likewise rotate with the tabletop 102. Further, in the example of FIG. 4, when the tilt angle θ is set to a value of θ₁, where θₘᵢₙ<θ₁<θₘₐₓ, the compact tilt mechanism 204 does not collide with, or make contact with, the attached tools and/or devices (i.e., the manipulator arms 112). Given the originally-specified range of motion relative to the principal axis 402 specified by the standard range of tilt angles, it is expected that the tilt angle θ can be adjusted, by the compact tilt mechanism 204, to any value in the range [θₘᵢₙ, θₘₐₓ] without a collision between the compact tilt mechanism 204 and the attached tools and/or devices.

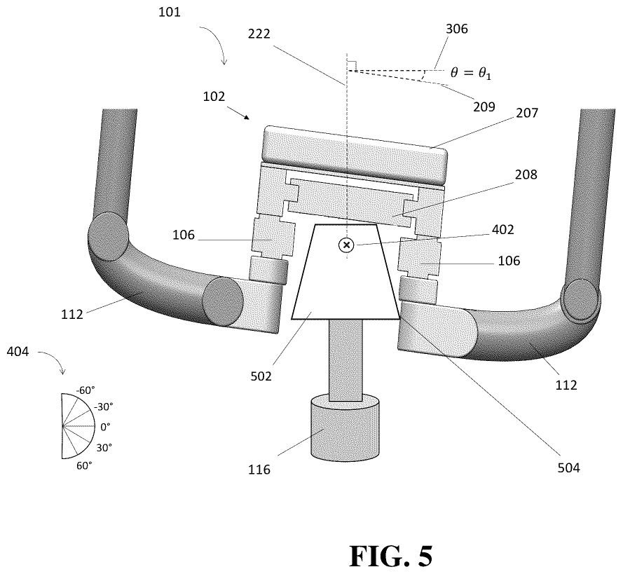

For comparison, FIG. 5 depicts the same view of a surgical table 101 as in FIG. 4, however, the surgical table 101 of FIG. 5 is configured with a non-compact tilt mechanism 502. Like in FIG. 4, the non-compact tilt mechanism 502 is disposed between, and forms a connection between, the support column 116 and the underside 208 of the tabletop 102. As seen in FIG. 5, the rail system 106 and attached, or otherwise integrated, tools and devices (i.e., the manipulator arms 112) likewise rotate with the tabletop 102. However, as seen in the example of FIG. 5, when the tilt angle θ is set to the value θ₁, the non-compact tilt mechanism 502 collides with, or makes contact with, the manipulator arms 112 at a point of collision 504. In instances where it is desirable to rotate the tabletop 102 about the principal axis 402 such that the tilt angle θ is greater than θ₁, the collision between the non-compact tilt mechanism 502 and manipulator arms 112 prohibits additional rotation. Thus, in the example depicted in FIG. 5, rotation of the tabletop 102 about the principal axis 402 is limited to the angle θ1 where θ₁<θₘₐₓ. As such, it may not be possible to optimally position a patient during a procedure due to collision between the non-compact tilt mechanism 502 and the manipulator arms 112. While moving a collision-causing manipulator arm may be an option, this can limit suitable locations or workspace of the manipulator arm, may inhibit motion of the manipulator arm, and may disrupt an ongoing procedure.

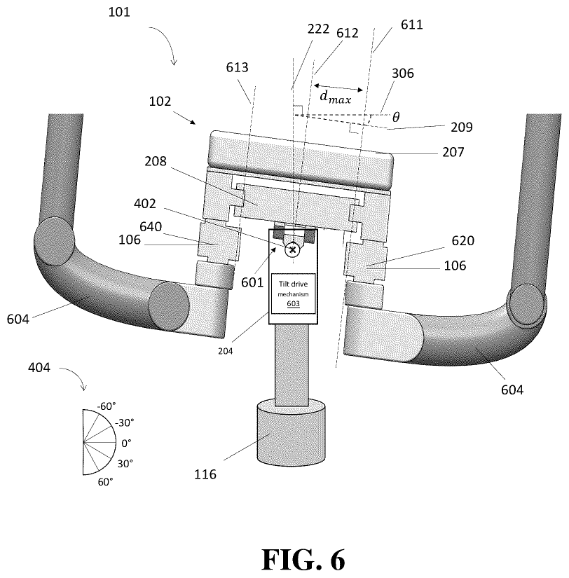

Turning to FIG. 6, FIG. 6 further generalizes aspects of the surgical table 101 and the compact tilt mechanism 204 disclosed herein. In accordance with one or more embodiments, FIG. 6 depicts a surgical table 101 that includes a tabletop 102 with a top surface 207 and an underside 208, where the underside 208 of the tabletop 102 is connected to a support column 116 by means of a compact tilt mechanism 204. The surgical table 101 can include a rail system 106 that is fixedly attached to the underside 208 or sides of the tabletop 102, either directly or via one or more intermediate components, and moves with the tabletop 102 (e.g., translation, rotation). The rail system 106 facilitates the attachment of one or more tools and/or devices. To promote generalization, FIG. 6 depicts attached tooling 604 attached to the tabletop 102 by the rail system 106. The attached tooling 604 can be any tool or device that is attached to, or otherwise integrated with, the surgical table 101 (e.g., manipulator arms 112). In one or more embodiments, the attached tooling 604 is configured to be stored beneath the surgical table 101 (i.e., proximate to the underside 208). As before, a first plane 209 is defined to be parallel with the top surface 207 of the tabletop 102.

In one or more embodiments, the compact tilt mechanism 204 is composed of a center pivot 601 and a tilt drive mechanism 603. As depicted in FIG. 6, the center pivot 601 defines the principal axis 402 and is the physical component that couples the underside 208 of the tabletop 102 to the support column 116. In general, the center pivot 601 can be coupled to any portion of the underside 208 of the tabletop 102 and need not be disposed to form or imply any type of symmetry for the surgical table 101. That is, the center pivot 601 does not need to be centered with tabletop 102 along any given span. The tilt drive mechanism 603 provides the means to pivot the tabletop 102 relative to the support column 116 about the principal axis 402.

As seen in FIG. 6, the tabletop 102 is rotated about the principal axis 402 such that the intersection of the first plane 209 and a plane orthogonal to the principal axis 402 relative to the intersection of the horizontal plane 306 and the plane orthogonal to the principal axis 402 forms a tilt angle θ. For rotation of the tabletop 102 about the principal axis 402, a standard range of tilt angles, [θₘᵢₙ, θₘₐₓ], is given. Further, the value of the tilt angle θ is defined according to an angular datum 404. In accordance with one or more embodiments, the compact tilt mechanism 204 is configured such that, even in the presence of attached tooling 604, the tabletop 102 can be rotated about the principal axis 402 fully through the originally-specified range of motion. That is, the tilt angle θ can take any value equal to and between θₘᵢₙ and @max (i.e., θₘᵢₙ≤θ≤θₘₐₓ) without a collision between the compact tilt mechanism 10 and the attached tooling 604, even when the attached tooling 604 is stored beneath the tabletop 102 (i.e., proximate the underside 208). More specifically, in accordance with one or more embodiments, the tilt angle θ can take any value in the range [θₘᵢₙ, θₘₐₓ] without a collision between the tilt drive mechanism 603 and the attached tooling 604.

In one or more embodiments, this feature, that the tilt drive mechanism 603 of the compact tilt mechanism 204 does not collide with attached tooling 604 for any tilt angle θ in the range [θₘᵢₙ, θₘₐₓ], is enforced through the following geometric constraint. In accordance with one or more embodiments, a second plane is defined such that the second plane is orthogonal to the first plane 209 (or orthogonal to the top surface 207), parallel with the principal axis 402, and intersects the tabletop. Further, in one or more embodiments, the second plane is tangent to an “innermost” point or surface of the attached tooling 604 proximate the compact tilt mechanism 204. Herein, the compact tilt mechanism 204 and attached tooling 604 are considered proximate if the compact tilt mechanism 204 and attached tooling 604 are coplanar with a plane orthogonal to the principal axis 402. In one or more embodiments, the rail system 106 includes a right-hand side (RHS) rail 620 and a left-hand side (LHS) rail 640. FIG. 6 further depicts a third plane 612 orthogonal to the first plane 209, parallel with the principal axis 402, and intersecting with the principal axis 402. An innermost point or surface of the rail system 106 is determined by displacing the second plane a maximum distance, dₘₐₓ, from the third plane without intersecting the attached tooling 604 (again, it is emphasized that this determination is made proximate the compact tilt mechanism 204). In instances where the rail system 106 includes a LHS rail 640 and a RHS rail 620 (or any multiplicity of sub-rails), an innermost point or surface is determined for each sub-rail and an instance of the second plane can be placed at any attached tooling 604 connected to each sub-rail. For example, FIG. 6 depicts a fourth plane 611 tangent with the innermost surface of the attached tooling 604 on the RHS rail 620 and a fifth plane 613 tangent with the innermost surface the attached tooling 604 of the LHS rail 640. In such a case, two instances of second plane can be considered where one instance is coplanar with the fourth plane 611 or the other instance is coplanar with the fifth plane 613, regardless of the distance between the third plane 612 and the fourth and fifth planes (611, 613). The compact tilt mechanism 204 is configured such that the tilt drive mechanism 603 clears the second plane (or all instances of the second plane) as the second plane pivots along with the tabletop 102 about the principal axis 402 through the originally-specified range of motion (i.e., all tilt angles θ in the range [θₘᵢₙ) θₘₐₓ]). In other words, the tilt drive mechanism 603 and any attached tooling 604 do not collide throughout the originally-specified range of motion, e.g., up to +/−40 degrees. While FIG. 6 depicts the attached tooling as being in use (i.e., extended outwards from the surgical table 101), the attached tooling 604 can be stowed underneath the tabletop 102 without departing from the scope of this disclosure. In one or more embodiments, the second plane (or one or more instances of the second plane) is located at an innermost surface or point of the rail system 106 if the maximum distance, dₘₐₓ, from the third plane to a parallel plane intersecting with the rail system 106 is less than the distance to a parallel plane intersecting with attached tooling 604.

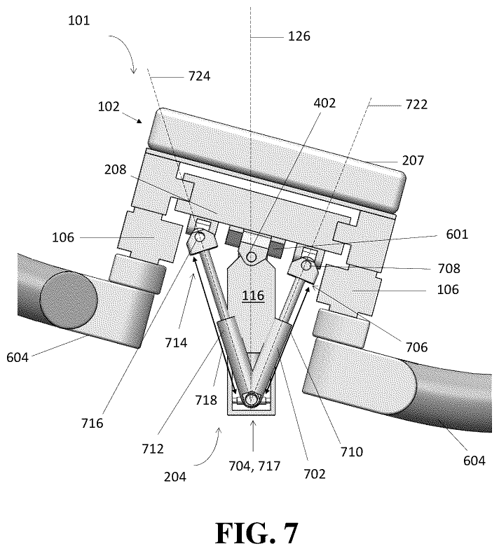

FIG. 7 depicts the tilt drive mechanism 603 of the compact tilt mechanism 204 in accordance with one or more embodiments. As seen in FIG. 7, the tilt drive mechanism 603 can include a first link 702 along a first link axis 722. The first link 702 has a first end 704 and a second end 706 along with a first joint 708. In this embodiment, the first joint 708 is rotatably coupled to the underside 208 of the tabletop 102. Further, the first end 704 of the first link 702 is rotatably coupled to the support column 116 and the second end 706 is connected to the first joint 708. The first link 702 is extendable and retractable along the first link axis 722 which is non-parallel to the column axis 126. Extension and retraction of the first link 702 cause the tabletop 102 to tilt about the principal axis 402. In one or more embodiments, the first link 702 is a linear actuator, such as a leadscrew, ball screw, rack and pinion assembly, or hydraulic or pneumatic cylinder. An advantage of this embodiment is that the first link 702 is proximate to the support column 116 reducing the amount space underneath the surgical table 101 occupied by tilt drive mechanism 603.

In some embodiments, and also illustrated in FIG. 7, the tilt drive mechanism 603 can include a first link 702 along a first link axis 722 that is non-parallel to the column axis 126 and having a first end 704 and a second end 706, and a second link 712 along a second link axis 724 that is non-parallel to the column axis 126 and having a third end 717 and a fourth end 714. This embodiment further includes a first joint 708 and a second joint 716. The first joint 708 is rotatably coupled to the underside 208 of the tabletop 102. Likewise, the second joint 716 is rotatably coupled to the underside 208 of the tabletop 102. Further, the first end 704 of the first link 702 is rotatably coupled to the support column 116 and the second end 706 is connected to the first joint 708. The third end 717 of the second link 712 is rotatably coupled to the support column 116 and the fourth end 714 is connected to the second joint 716. The first link 702 is extendable and retractable along the first link axis 722, enabling adjustment of a first length 710 between the support column 116 and the underside 208 of the tabletop 102. The second link 712 is extendable and retractable along the second link axis 724, enabling adjustment of a second length 718 between the support column 116 and the underside 208 of the tabletop 102. In one or more embodiments, the first link 702 and the second link 712 are linear actuators, such as a leadscrew, ball screw, rack and pinion assembly, or hydraulic or pneumatic cylinder. It is noted that there is no requirement that the first link 702 and the second link 712 be the same type of linear actuator.

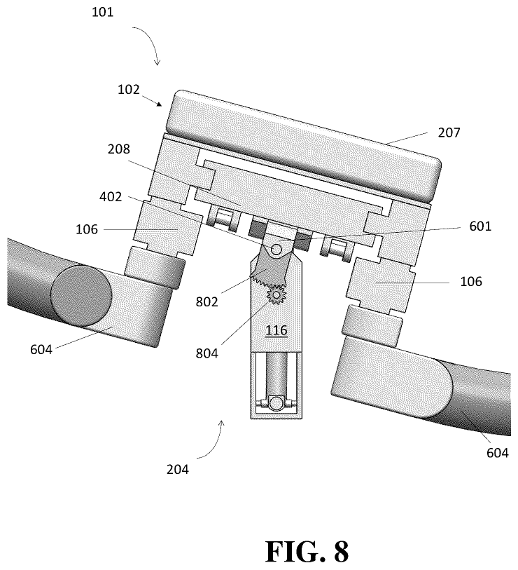

FIG. 8 depicts the tilt drive mechanism 603 of the compact tilt mechanism 204 in accordance with one or more embodiments. As seen in FIG. 8, the tilt drive mechanism 603 can include a sector gear 802 fixedly attached to the center pivot 601. The sector gear 802 can be mated, or meshed, with a pinion gear 804. In one or more embodiments, the pinion gear 804 is configured to be driven by a motor (not shown). In some embodiments, the motor is disposed on the support column 116. In other embodiments, the motor is enclosed by the support column 116. As depicted in FIG. 8, the pinion gear 804 transmits torque to the sector gear 802 to adjust the angular position of the tabletop 102 (i.e., rotate the tabletop 102 about the principal axis 402) in response to being driven by the motor. In general, the relative sizes of the sector gear 802 and pinion gear 804 can be selected, in coordination with the specifications of the motor, in order to apply a desired torque to the tabletop 102 according to an angular velocity and to adjust the angular position of the tabletop 102 within a desired angular resolution. Likewise, the desired torque, or torque requirement, can be determined based on an expected force imbalance exerted upon the tabletop 102, where the torque requirement may be magnified by a safety factor selected by an engineer. In one or more embodiments, the sector gear 802 and/or the pinion gear 804 can be enclosed, or disposed within, the support column 116. Consequently, a perceived advantage of this embodiment is that the tilt drive mechanism 603 (and the compact tilt mechanism 204 as a whole) will occupy no more space under a surgical table 101 than already occupied by a support column 116. In one or more embodiments, the pinion gear 804 is replaced with a cable-wrapped drum, where the ends of the cable terminate on opposing sides of the sector gear 802. In such a case, the sector gear 802 may not have any teeth.

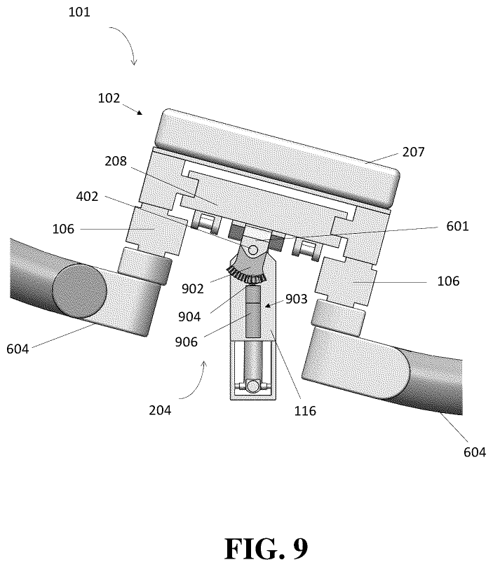

FIG. 9 depicts the tilt drive mechanism 603 of the compact tilt mechanism 204 in accordance with one or more embodiments. As seen in FIG. 9, the tilt drive mechanism 603 can include a face sector gear 902 fixedly attached to the center pivot 601, where the face sector gear 902 has a plurality of teeth disposed on its face. The face sector gear 902 also has a first axis of rotation. This embodiment can further include a face gear drive 903 that includes a drive shaft 906 and a perpendicular gear 904 such as a bevel gear or hypoid gear. The perpendicular gear also having a second axis of rotation. The face sector gear 902 can be mated, or meshed, with the perpendicular gear 904, where the first axis of rotation and the second axis of rotation are orthogonal. In one or more embodiments, the drive shaft 906, or the perpendicular gear 904 in general, is configured to be driven by a drive unit 903. The drive unit may include a motor 906 and/or a gear reducer 905. Alternatively, the drive unit 903 may include a drive shaft, with the motor being located elsewhere. In some embodiments, the drive unit 903 is oriented parallel to vertical axis 222. In some embodiments, the drive unit 903 is disposed on the support column 116. In other embodiments, the drive unit 903 is enclosed by the support column 116. As depicted in FIG. 9, the perpendicular gear 904 transmits torque to the face sector gear 902 to adjust the angular position of the tabletop 102 (i.e., rotate the tabletop 102 about the principal axis 402) in response to being driven by the motor. In general, the relative sizes of the face sector gear 902 and perpendicular gear 904 can be selected, in coordination with the specifications of the motor, in order to apply a desired torque to the tabletop 102 according to an angular velocity and to adjust the angular position of the tabletop 102 within a desired angular resolution. The desired torque, or torque requirement, can be determined based on an expected force imbalance exerted upon the tabletop 102, where the torque requirement may be magnified by a safety factor selected by an engineer. In one or more embodiments, the face sector gear 902 and/or the face gear drive 903 can be enclosed, or disposed within, the support column 116. Consequently, a perceived advantage of this embodiment is that the tilt drive mechanism 603 (and the compact tilt mechanism 204 as a whole) will occupy no more space under a surgical table 101 than already occupied by a support column 116.

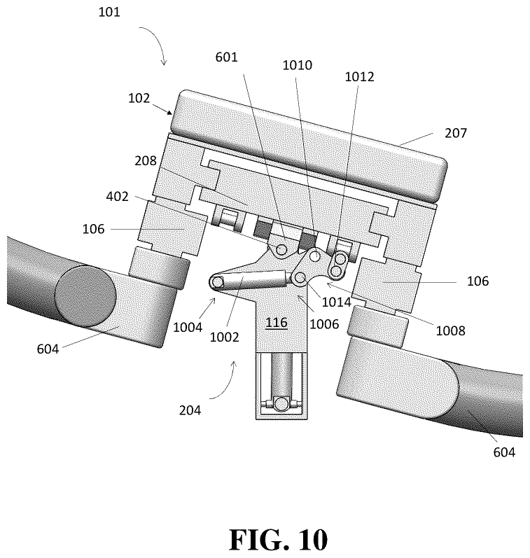

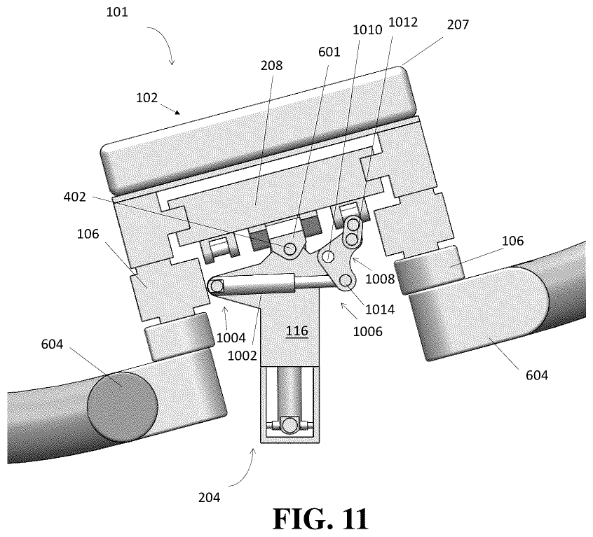

FIG. 10 depicts the tilt drive mechanism 603 of the compact tilt mechanism 204 in accordance with one or more embodiments. As seen in FIG. 10, the tilt drive mechanism 603 can include a linear actuator 1002, such as a hydraulic or pneumatic cylinder, and a bellcrank 1008. The linear actuator 1002 has a first end 1004 rotatably connected to the support column and a second end 1006 coupled to a second moving pivot 1014 of the bellcrank 1008. The bellcrank 1008 includes a fixed pivot 1010 connected to the support column 116 and about which the bellcrank 1008 can rotate. The bellcrank 1008 further includes a first moving pivot 1012 forming a coupling (e.g., a joint) with the underside 208 of the tabletop 102. The linear actuator 1002 is configured to be adjustable in its length. As seen in FIG. 10, the angular position of the tabletop 102 (i.e., the rotation of the tabletop 102 about the principal axis 402) is adjusted in response to changes in the length of the linear actuator 1002. In particular, FIG. 10 depicts the linear actuator 1002 in a contracted, or shortened, configuration resulting in the tabletop 102 rotating clockwise about the principal axis 402 relative to the viewpoint provided by FIG. 10. FIG. 11 depicts the same embodiment as FIG. 10, however, in FIG. 11 the linear actuator 1002 is depicted in an extended, or lengthened, configuration resulting in the tabletop 102 rotating counter-clockwise about the principal axis 402 relative to the viewpoint of provided by FIG. 11. In general, the relative placement of the first moving pivot 1012, second moving pivot 1014, and fixed pivot 1010 of the bellcrank 1008, as well as the location of the bellcrank 1008 on the support column 116, can be adjusted in order to tailor the interaction and sensitivity between the angular adjustment of the tabletop 102 and the length of the linear actuator 1002. A perceived advantage of this embodiment is that the bellcrank 1008 redirects the approximately vertical force vector required to adjust the angular position of the tabletop 102 to an approximately horizontal force vector, where the horizontal force vector is provided by the linear actuator 1002. Due to the redirection of force, the linear actuator 1002 can be “tucked up” near the underside 208 of the tabletop 102 increasing space underneath the surgical table 101 reducing the likelihood of collisions between the tilt drive mechanism 603 and the attached tooling 604.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A surgical table comprising:
a tabletop comprising:
a top surface, and
an underside;
a support column that elevates the tabletop relative to a floor along a column axis;
at least one mechanical interface for attaching a device to the tabletop; and
a tilt mechanism connecting the support column and the tabletop, comprising:
a center pivot that defines a principal axis and couples the underside of the tabletop to the support column; and
a tilt drive mechanism to rotate the tabletop about the principal axis, comprising:
a first link having a first end and a second end; and
a first joint rotatably coupled to the underside of the tabletop;
wherein the first end of the first link is connected to the support column and the second end is connected to the first joint,
wherein the first link is extendable and retractable along a first link axis between the support column and the underside of the tabletop to cause the tabletop to tilt about the principal axis, the first link axis being non-parallel to the column axis.

2. The surgical table of claim 1, wherein the tilt drive mechanism further comprises:
a second link having a third end and a fourth end; and
a second joint rotatably coupled to the underside of the tabletop;
wherein the third end of the second link is coupled to the support column and the fourth end of the second link is connected to the second joint,
wherein the second link is extendable and retractable along a second link axis between the support column and the underside of the tabletop to cause the tabletop to tilt about the principal axis, the second link axis being non-parallel to the column axis

3. The surgical table of claim 1, wherein the tilt drive mechanism clears a first plane perpendicular to the top surface of the tabletop, parallel to the principal axis and tangential to an innermost point or surface of the device, as the first plane pivots along with the tabletop for a rotation about the principal axis of up to 40 degrees.

4. The surgical table of claim 1, wherein the device and the tilt mechanism are coplanar to a second plane orthogonal to the principal axis.

5. The surgical table of claim 1, further comprising the device.

6. The surgical table of claim 1, wherein the device is a manipulator arm.

7. A surgical table comprising:
a tabletop comprising:
a top surface, and
an underside;
a support column that elevates the tabletop relative to a floor;
at least one mechanical interface for attaching a device to the tabletop; and
a tilt mechanism connecting the support column and the tabletop, comprising:
a center pivot that defines a principal axis and couples the underside of the tabletop to the support column; and
a tilt drive mechanism to rotate the tabletop relative to the support column about the principal axis, comprising:
a motor;
a first gear fixedly attached to the center pivot; and
a second gear driven by the motor and positioned to mesh with the first gear;
wherein the second gear transmits torque to the first gear to adjust an angular position of the tabletop in response to being driven by the motor.

8. The surgical table of claim 7, wherein the first gear is a sector gear.

9. The surgical table of claim 7,
wherein the first gear has a first axis of rotation and the second gear has a second axis of rotation perpendicular to the first axis of rotation.

10. The surgical table of claim 14, wherein the first gear, the second gear, and the motor are enclosed by the support column.

11. The surgical table of claim 7, wherein the tilt drive mechanism clears a first plane perpendicular to the top surface of the tabletop, parallel to the principal axis and tangential to an innermost point or surface of the device, as the first plane pivots along with the tabletop for a rotation about the principal axis of up to 40 degrees.

12. The surgical table of any of claim 7, wherein the device and the tilt mechanism are coplanar to a second plane orthogonal to the principal axis.

13. The surgical table of claim 7, further comprising the device.

14. The surgical table of any of claim 7, wherein the device is a manipulator arm.

15. A surgical table comprising:
a tabletop comprising:
a top surface, and
an underside;
a support column that elevates the tabletop relative to a floor;
at least one mechanical interface for attaching a device to the tabletop; and
a tilt mechanism connecting the support column and the tabletop, comprising:
a center pivot that defines a principal axis and couples the underside of the tabletop to the support column; and
a tilt drive mechanism to rotate the tabletop relative to the support column about the principal axis, comprising:
a linear actuator with a first end rotatably connected to the support column and a second end, wherein the linear actuator is configured with an adjustable length; and
a bellcrank comprising:
a fixed pivot rotatably connected to the support column;
a first moving pivot coupled to an underside of the tabletop; and
a second moving pivot coupled to the second end of the linear actuator;
wherein an angular position of the tabletop is adjusted in response to changes of the adjustable length of the linear actuator.

16. The surgical table of claim 15, wherein the linear actuator is one selected from a group consisting of:
a pneumatic cylinder,
a hydraulic cylinder,
a leadscrew, and
a rack and pinion.

17. The surgical table of claim 15, wherein the tilt drive mechanism clears a first plane perpendicular to the top surface of the tabletop, parallel to the principal axis and tangential to an innermost point or surface of the device, as the first plane pivots along with the tabletop for a rotation about the principal axis of up to 40 degrees.

18. The surgical table of claim 15, wherein the device and the tilt mechanism are coplanar to a second plane orthogonal to the principal axis.

19. The surgical table of claim 15, further comprising the device.

20. The surgical table of claim 15, wherein the device is a manipulator arm.
